(19) United States
(12) Patent Application Publication
(10) Pub. No.: US 2005/0248557 A1
(43) Pub. Date: Nov. 10, 2005

(54) Picture signal processing device, display device, receiver, and display method

(75) Inventor: Hirotoshi Miyazawa, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/054,386

(22) Filed: Feb. 10, 2005

(30) Foreign Application Priority Data
Apr. 23, 2004 (JP) 2004-128234

(51) Int. Cl. G09G 5/00

(52) U.S. Cl. 345/204

(57) ABSTRACT

The gradation representation capability is automatically controlled according to gradation regions and properties (moving or still image) of an input video signal. In a gradation representation pattern information storage circuit is stored a plurality of pieces of gradation representation pattern information which are different in the number of repetition unit frames for gradation representation according to a plurality of degradation regions. One piece of gradation representation pattern information stored in the gradation representation pattern information storage circuit is selected according to a gradation region detected from an input video signal. Gradation representation data of the frame rate corresponding to the selected gradation representation pattern information is output.

### CROSS-REFERENCE TO RELATED APPLICATIONS

This application is based upon and claims the benefit of priority from prior Japanese Patent Application No. 2004-128234, filed Apr. 23, 2004, the entire contents of which are incorporated herein by reference.

### BACKGROUND OF THE INVENTION

1. Field of the Invention

The present invention relates to a video signal processing device, a display device, a receiver, and a display method which are adapted to perform multi-gradation control through frame-rate control (FRC) using a liquid crystal display device, a plasma display device, or the like.

2. Description of the Related Art

For example, one method for controlling gradation in liquid crystal display devices is frame-rate control (FRC). In the FRC method, a certain number of frames is set as a unit and the number of times (the number of frames) target pixels are turned on within the frame unit is controlled according to gradation. When the pixels are turned on in all the frames within the frame unit (the number of times the pixels are turned on is maximum), a bright display is obtained (gradation is high). When the pixels are turned on in a few frames (the number of times the pixels are turned on is very small), a dark display is obtained (gradation is low). This technique is also described in, for example, Japanese Unexamined Patent Publication No. 2002-149118.

With the conventional FRC method, gradation representation is controlled within the range of a predetermined number of frames. For this reason, the gradation representation capability is subject to restrictions. Further, depending on the speed of moving images (a change with each frame), interference may occur due to a relationship between the number of unit frames for gradation representation and the speed of image motion, which causes problems such as flicker, striped patterns, etc., on the screen.

### BRIEF SUMMARY OF THE INVENTION

It is an object of the present invention to provide a video signal processing device, display device, receiver, and display method which permit the gradation representation capability to be automatically controlled according to gradation regions and properties (moving or still image) of an input video signal.

According to an aspect of the present invention, there is provided a video signal processing device comprising: a gradation representation pattern information storage circuit which stores a plurality of pieces of gradation representation pattern information which are different in the number of repetition unit frames for gradation representation according to a plurality of degradation regions; a gradation region detection circuit which detects a gradation region in an input video signal; a pattern information selection circuit which selects one piece of gradation representation pattern information stored in the gradation representation pattern information storage circuit according to the gradation region detected by the gradation region detection circuit; and an output circuit which outputs gradation representation data of the frame rate corresponding to the gradation representation pattern information selected by the pattern information selection circuit.

As described above, the gradation representation pattern information storage circuit is prepared which stores a plurality of pieces of gradation representation pattern information which are different in the number of repetition unit frames for gradation representation according to a plurality of degradation regions. One piece of gradation representation pattern information stored in the gradation representation pattern information storage circuit is selected according to a gradation region detected from an input video signal. Therefore, gradation representation can be carried out appropriately to suit the contents of an input video signal. In addition, gradation representation can be made in which flicker is less likely to occur and the gradation representation capability as a whole can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic exterior view of a display device to which the present invention is applied;

FIG. 2 is a block diagram of an embodiment of the present invention;

FIG. 3 is a diagram for use in explanation of an example of a gradation region-to-frame rate mapping table stored in the gradation representation pattern information storage circuit shown in FIG. 2;

FIG. 4 is a block diagram of another embodiment of the present invention;

FIG. 5 is a block diagram of still another embodiment of the present invention;

FIGS. 6A, 6B and 6C illustrate other examples of gradation region-to-frame rate mapping tables each stored in the gradation representation pattern information storage circuit shown in FIG. 2;

FIG. 7 is a schematic representation of a television receiver to which the present invention is applied;

FIG. 8 is a flowchart when the functional blocks shown in FIG. 2 are implemented in software;

FIG. 9 is a flowchart when the functional blocks shown in FIG. 4 are implemented in software; and

FIG. 10 is a flowchart when the functional blocks shown in FIG. 5 are implemented in software.

### DETAILED DESCRIPTION OF THE INVENTION

The preferred embodiments of the present invention will be described hereinafter with reference to the accompanying drawings.

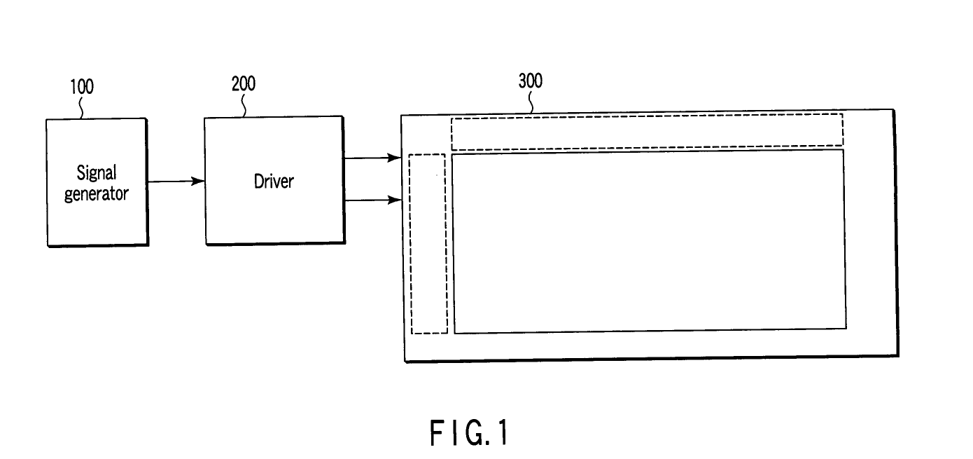

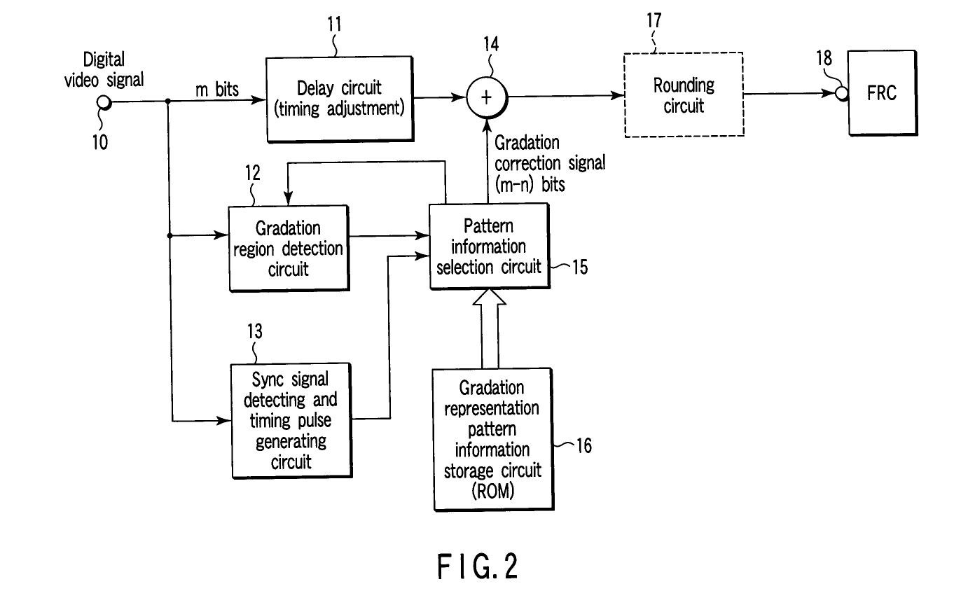

FIG. 1 schematically shows the overall arrangement of a liquid crystal display device to which the present invention is applied. FIG. 2 is a block diagram of an embodiment of the present invention.

In FIG. 1, 100 denotes a signal generator which is, for example, a television tuner, a set-top box, a personal computer, or the like and outputs video information. The video information is input to a driver 200 for conversion into a signal for display. The resulting display signal is then applied to a display device 300 which is a liquid crystal display device, for example.

FIG. 2 is a block diagram of a signal processing unit according to the present invention. The signal processing unit is integrally incorporated into the driver 200 or the display device 300. In FIG. 2, a digital video signal (for example, m bits) is applied through an input terminal 10 to a delay circuit (circuit for timing adjustment) 11, a gradation region detection circuit 12, and a sync signal detecting and timing pulse generating circuit 13. The sync signal detecting and timing pulse generating circuit 13 detects vertical sync signals and horizontal sync signals in the digital video signal to reproduce vertical sync pulses, horizontal sync pulses, clock pulses, and various timing pulses.

Gradation region information detected by the gradation region detection circuit 12 is applied to a pattern information selection circuit 15, which selects gradation representation pattern information stored in a gradation representation pattern information storage circuit 16 in accordance with the detected gradation region. The selected gradation representation pattern information is input to an adder 14 as a gradation correction signal of (m−n) bits by way of example.

Here, a digital video signal for each pixel timing-adjusted by the delay circuit 11 and the corresponding gradation correction signal are added together in the adder 14. The resulting digital signal has its low-order (m−n) bits rounded off in a rounding circuit 17 and is then transferred to an output terminal 18 as a gradation-corrected digital signal of n (m>n) bits. The digital signal has a frame rate for gradation representation set and is used as a blinking signal for the corresponding pixel. That is, the digital signal is used for control of writing data into the corresponding pixel. Note that the rounding circuit 17 may be omitted.

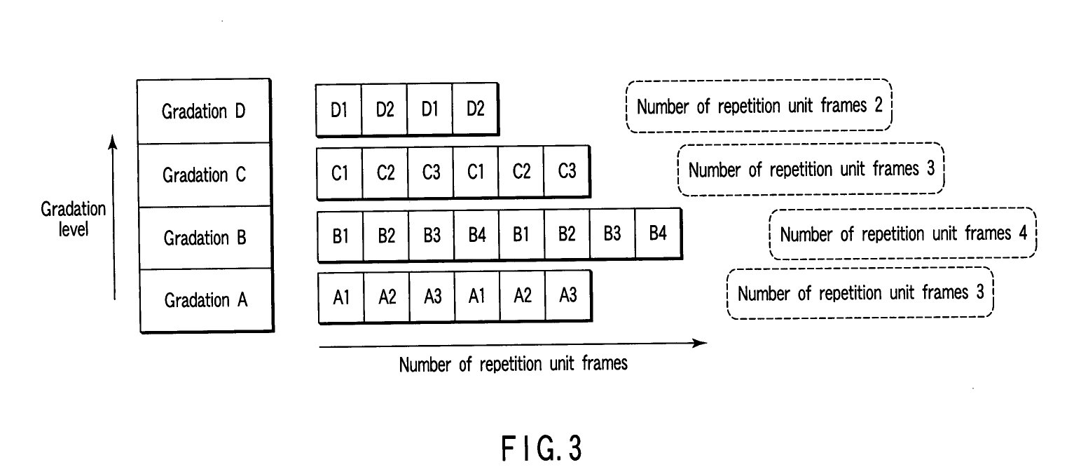

FIG. 3 shows an example of pattern information stored in the gradation representation pattern information storage circuit 16.

In this embodiment, the gradation regions are classified into, for example, four regions A, B, C, and D in ascending order of gradation.

In FIG. 3, for example, three kind of the gradation representation patterns are assigned for the region A. Four kind of the gradation representation patterns are assigned for the region B. Three kind of the gradation representation patterns are assigned for the region C. Two kind of the gradation representation patterns are assigned for the region D.

In the region A, the number of repetition unit frames for representing gradation is set to, for example, three. That is, in this case, three kind of gradation representing patterns as data are subjected for three times of frames. In the region B, the number of repetition unit frames for representing gradation is set to, for example, four. That is, in this case, four kind of gradation representing patterns as data are subjected for four frames. There for, the ability of gradation representing is progressed than that of the region B.

In the region C, the number of repetition unit frames for representing gradation is set to, for example, three. In the region D, the number of repetition unit frames for representing gradation is set to, for example, two.

This means that the gradation representation capability varies with the gradation regions and the regions A, B, C and D have representation capabilities of 2×2×2=8, 2×2×2×2=16, 2×2×2=8, and 2×2=4, respectively. That is, in the present invention, an input video signal is corrected so that the number of repetition unit frames for representing gradation varies with the gradation regions in the input signal. Moreover, the intermediate gradation region is set sufficiently high in gradation representation capability.

That is, with liquid crystal display devices and plasma display devices, the speed of response is not always constant but varies with display levels. Accordingly, utilizing the variation width of response speed, the present invention increases the number of frames for regions in which the response speed is slow to enhance the displayed gradation representation capability and decreases the number of frames for regions in which the response speed is high. Thereby, the generation of flicker is suppressed.

The frame rate (the number of repetition unit frames) is determined in the pattern information selection circuit 15. The information is fed back to the gradation region detection circuit 12. This is intended to prevent the gradation region detection circuit 12 from changing the frame rate according to the result of the next gradation region detection until gradation representation of the corresponding pixel or pixel region at the determined frame rate is complete.

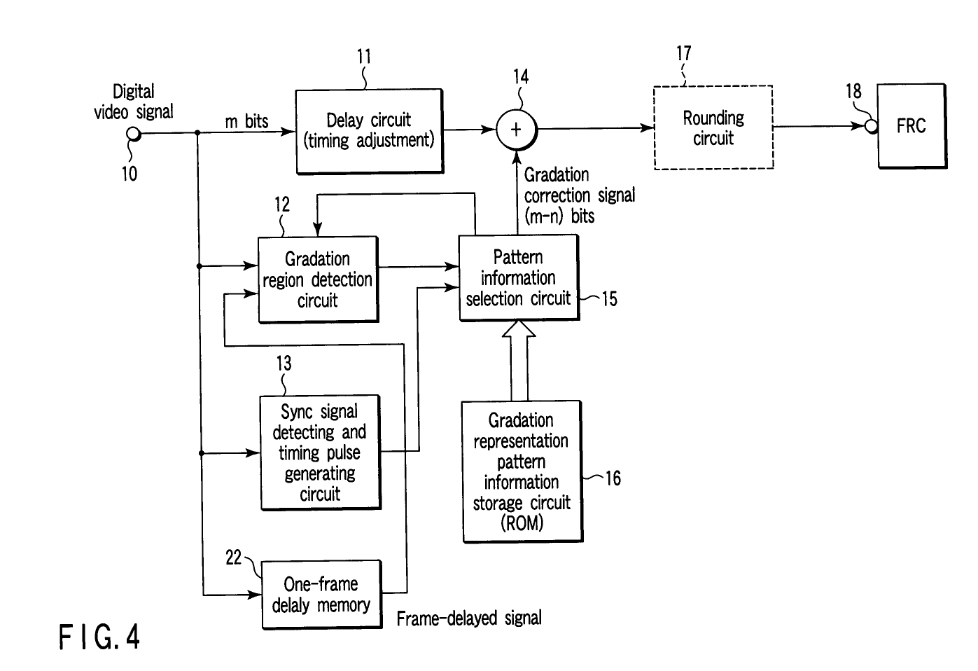

The present invention is not limited to the embodiment described so far. FIG. 4 shows another embodiment of the present invention. In this diagram, corresponding parts to those in FIG. 2 are denoted by like reference numerals. In the embodiment shown in FIG. 4, a one-frame delay memory 22 is added. The gradation region detection circuit 12 detects a change in gradation between a video signal in the current frame and a video signal in the preceding frame. When the change in gradation is great, the display device is judged to be high in response speed. Using the video signal in the current frame and the video signal in the preceding frame, the frame rate is switched according to a change in response speed due to a change in level. For example, the gradation region detection circuit 12 forces the pattern information selection circuit 15 to select pattern information in which the number of repetition unit frames is smaller (the frame rate is lower). If, when pattern information corresponding to the gradation B of FIG. 2 in which the number of repetition unit frames is four is selected, there is a great change in gradation, then pattern information corresponding to the gradation A or C in which the number of repetition unit frames is three will be selected. Thus, the gradation representation speed (representation capability) is allowed to follow the change in gradation.

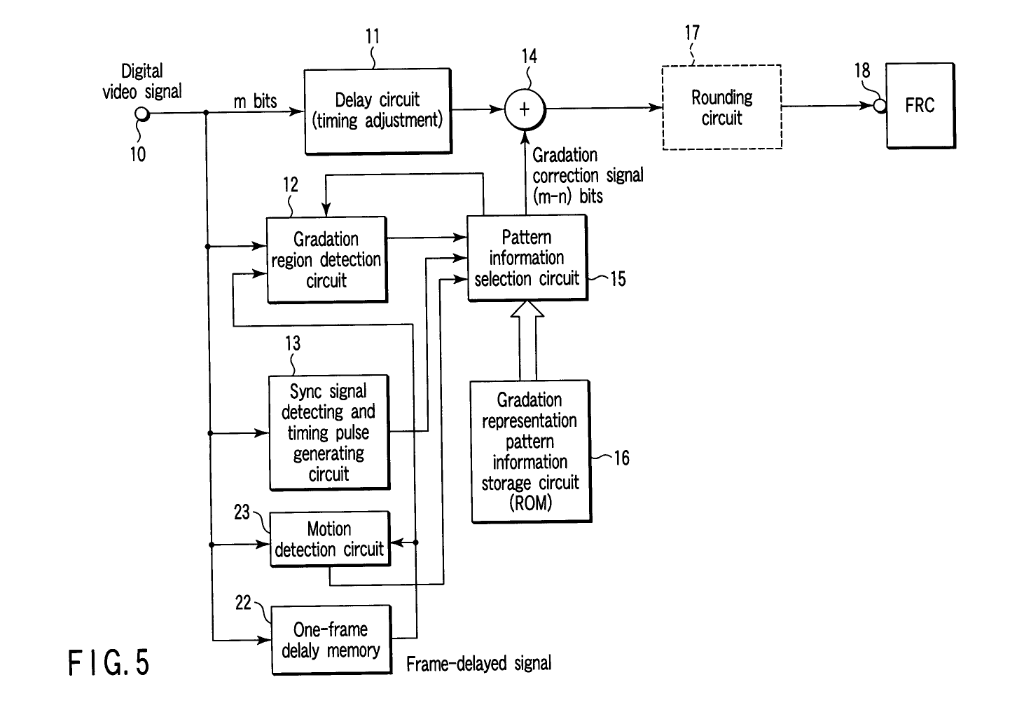

The present invention is not limited to the above embodiment. A motion detection circuit adapted to detect image motion may be further added to control conditions for pattern information selection according to the image motion. That is, as shown in FIG. 5, the motion detection circuit 23 detects image motion from video signals in the current frame and the preceding frame (the frame one frame before the current frame) to provide a motion detect signal. The motion detect signal is input to the gradation region detection circuit 12. In FIG. 5, the arrangement than the motion detection circuit 23 remains unchanged from that of FIG. 4 and hence corresponding parts to those in FIG. 4 are denoted by like reference numerals.

The display unit may have an improved response speed in order to handle moving images. Even if the result of the detection by the gradation region detection circuit 12 indicates that the region is low in response speed (e.g., the region B of intermediate gradation in FIG. 3), the display unit may have been set high in response speed in order to handle moving images. In such a case, forcibly selecting pattern information in which the number of repetition unit frames is reduced in accordance with the moving images will provide appropriate gradation representation. Thus, the pattern information selection circuit 15 makes reference to the motion detect signal as well and, if, when pattern information which corresponds to gradation B and in which the number of repetition unit frames is four is being selected, the image motion becomes faster than a set speed, forcibly selects pattern information which corresponds to gradation A or C and in which the number of repetition unit frames is three.

Three embodiments of the present invention have been described so far. In the embodiment shown in FIG. 1, in response to the detection of a gradation region the corresponding pattern information is selected from among such pattern information as shown in FIG. 3. In the embodiment shown in FIG. 4, pattern information is selected on the basis of the result of detection of a gradation region and interframe variation information. In the embodiment shown in FIG. 5, pattern information is selected on the basis of the result of detection of a gradation region, interframe variation information, and the motion detect signal.

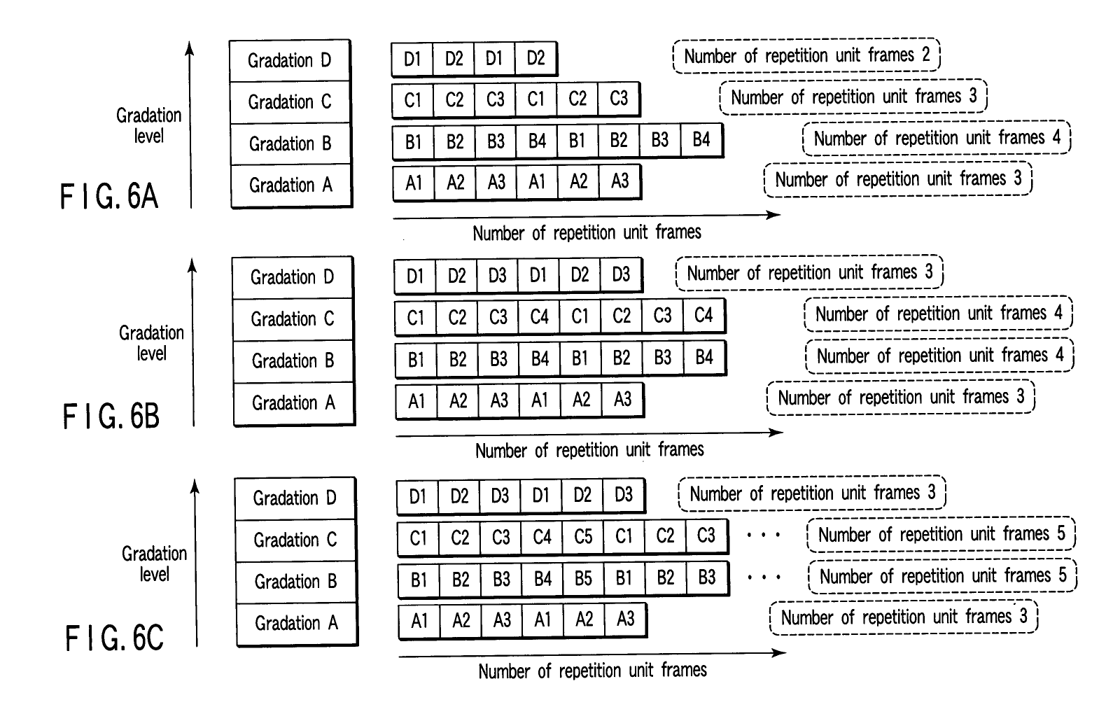

The present invention is not limited to the above embodiments. As shown in FIGS. 6A, 6B and 6C, a plurality of kinds of pattern information may be prepared as the gradation representation pattern information. That is, in the example of FIG. 6A, the region A has a representation capability of 2×2×2=8, the region B has a representation capability of 2×2×2×2=16, the region C has a representation capability of 2×2×2=8, and the region D has a representation capability of 2×2=4. In the example of FIG. 6B, the region A has a representation capability of 2×2×2=8, the region B has a representation capability of 2×2×2×2=16, the region C has a representation capability of 2×2×2×2=16, and the region D has a representation capability of 2×2×2=8. In the example of FIG. 6C, the region A has a representation capability of 2×2×2=8, the region B has a representation capability of 2×2×2×2×2=32, the region C has a representation capability of 2×2×2×2×2=32, and the region D has a representation capability of 2×2×2=8.

That is, first, second and third tables are stored in the gradation representation pattern information storage circuit 16. In the first table is set up first gradation representation pattern information such that the frame rate varies with each gradation region. In the second table is set up second gradation representation pattern information which is different in frame rate variable pattern from the first gradation representation pattern information. In the third table is set up third gradation representation pattern information which is different in frame rate variable pattern from the first and second gradation representation pattern information. The pattern information selection circuit 15 makes a selection from the first, second and third tables according to the gradation of an input video signal and image motion and uses the gradation representation pattern information in the selected table. Specifically, when image motion exists across the entire screen and the motion is fast, a table in which the average frame rate is low (the number of repetition unit frames is small) is selected. As the motion becomes slower, a table in which the average frame rate is higher (the number of repetition unit frames is larger) is selected.

The present invention is not limited to the above embodiments. The gradation regions may be classified into more than four regions A, B, C and D. According to the present invention, as described above, one of the gradation representation patterns can be set in real time for each pixel. The gradation representation patterns may be set for each region containing two or more pixels.

The present invention is not limited to the embodiments described above. At the stage of practice of the invention, constituent elements can be variously modified and embodied without departing from the scope and spirit thereof. The constituent elements disclosed in the above embodiments can be combined appropriately to form various inventions. For example, some elements may be removed from all the constituent elements shown in the embodiments. In addition, the constituent elements in the different embodiments may be combined appropriately.

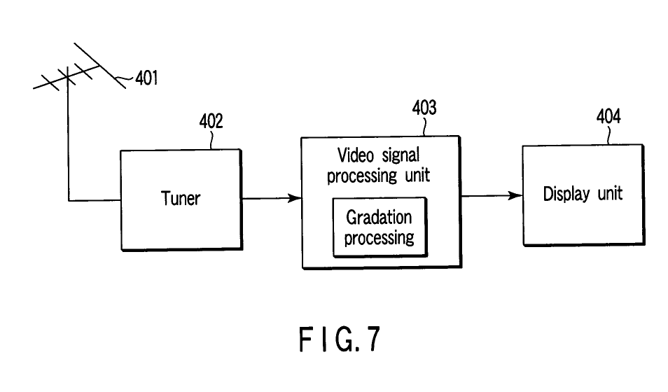

FIG. 7 shows a television receiver to which the present invention is applied. Radio-frequency broadcast signals picked up by an antenna 401 are applied to a tuner 402 where a channel is selected. An output signal of the tuner 402 is applied to a video signal processing unit 403 where gain control, color signal processing, brightness signal process and so on are performed. Further, in the video signal processing unit, the signal processing as described in connection with FIGS. 2 through 6 is carried out and the resulting output signal is output as a display signal to a display unit 404.

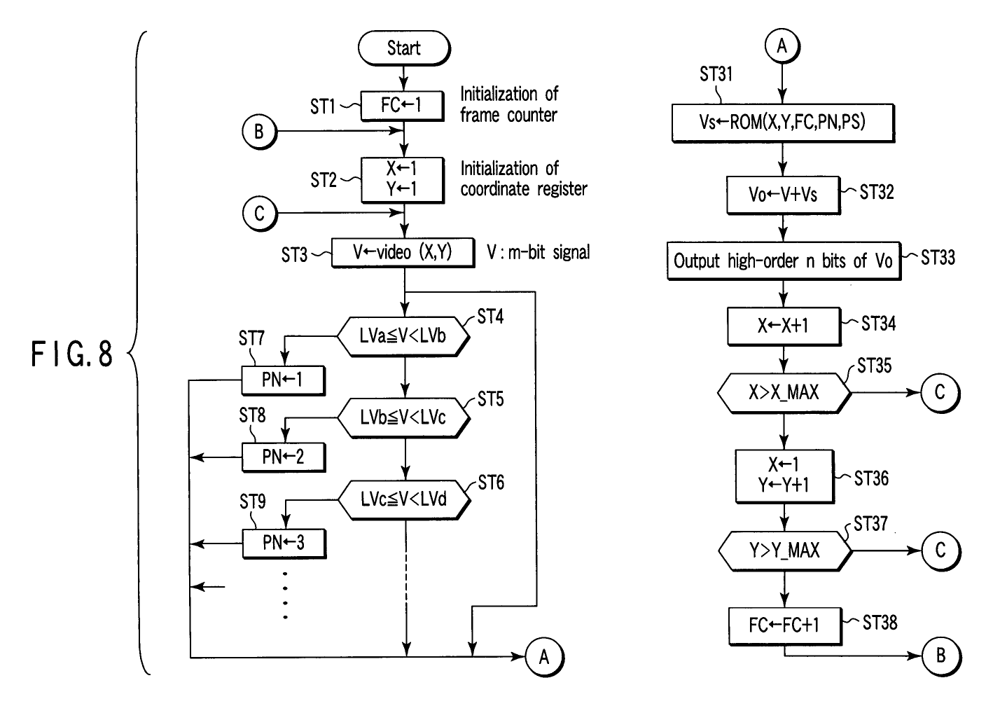

In FIGS. 8, 9 and 10 there are illustrated flowcharts for implementing the method of the invention. This means that the functional blocks shown in FIGS. 2, 4 and 5 can be implemented in software. The processing of FIG. 8 corresponds to the functions of the respective blocks shown in FIG. 2. In the gradation processing, a sync frame counter FC is first initialized in synchronization with a vertical sync signal (step ST1) and then a coordinate register (representing the position of a region or pixel in a frame) is initialized (step ST2). After that, the level of V (m bits) data in coordinate positions (X, Y) of a video signal is judged (steps ST3, ST4, ST5, ST6, ST7, ST8, and ST9). When the V data is at a first level, the parameter PN is set to 1 (PN←1). When the V data is at a second level, the parameter PN is set to 2 (PN←2). When the V data is at a third level, the parameter PN is set to 3 (PN←3). Thereby, the ROM address of pattern information for determining the corresponding frame rate is determined. The address is defined by ROM(X, Y, FC, PN). The pattern information (gradation correction signal) Vs (m−n bits) is read from that address (steps ST31 and ST32). The processing of Vs+V→Vo is carried out. After that, the high-order n bits of Vo is output through rounding processing.

Next, in steps ST34, ST35, ST36, and ST37, the address or region on the frame is updated. Upon completion of processing for one frame, the frame counter is incremented by one (step ST38). The gradation representation processing as described in connection with FIG. 2 is carried out on the basis of the flowchart described above.

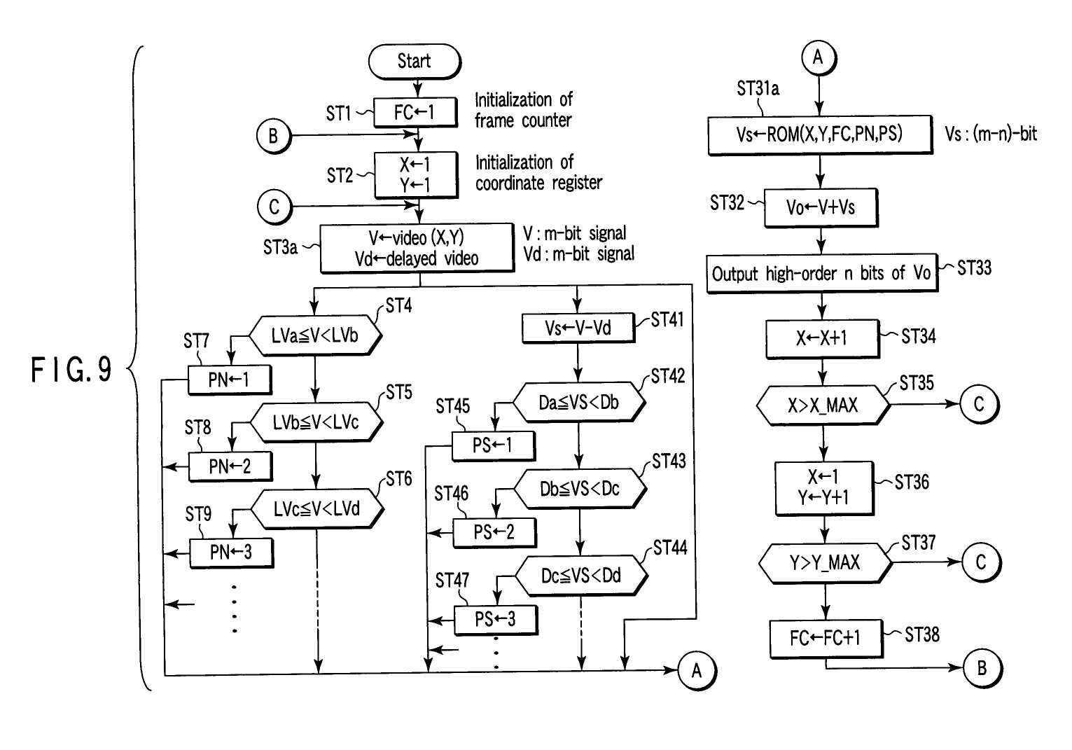

FIG. 9 shows a flowchart for implementing the functional blocks shown in FIG. 4 in software. In this diagram, corresponding steps to those in FIG. 8 are denoted by like reference numerals and descriptions thereof are omitted. Only the steps which are not present in the flowchart of FIG. 8 will be described. In step ST3a, V (m bits) in coordinate position (X, Y) in a video signal is read and Vd in the same coordinate position in the one-frame delayed video signal is read. The interframe difference Vs (←V−Vd) is taken and then the degree of Vs is judged relative to Da, Db and Dc. The parameter PS (1, 2, or 3) which is the condition for selecting pattern information is determined by the degree of Vs.

That is, as in step ST31a, the ROM address in which pattern information for determining the frame rate is stored is determined. The address is ROM(X, Y, FC, PN, PS). The pattern information (gradation correction signal) Vs (m−n bits) is read from that address (steps ST31 and ST32). The steps following step ST32 are the same as those in the flowchart of FIG. 8.

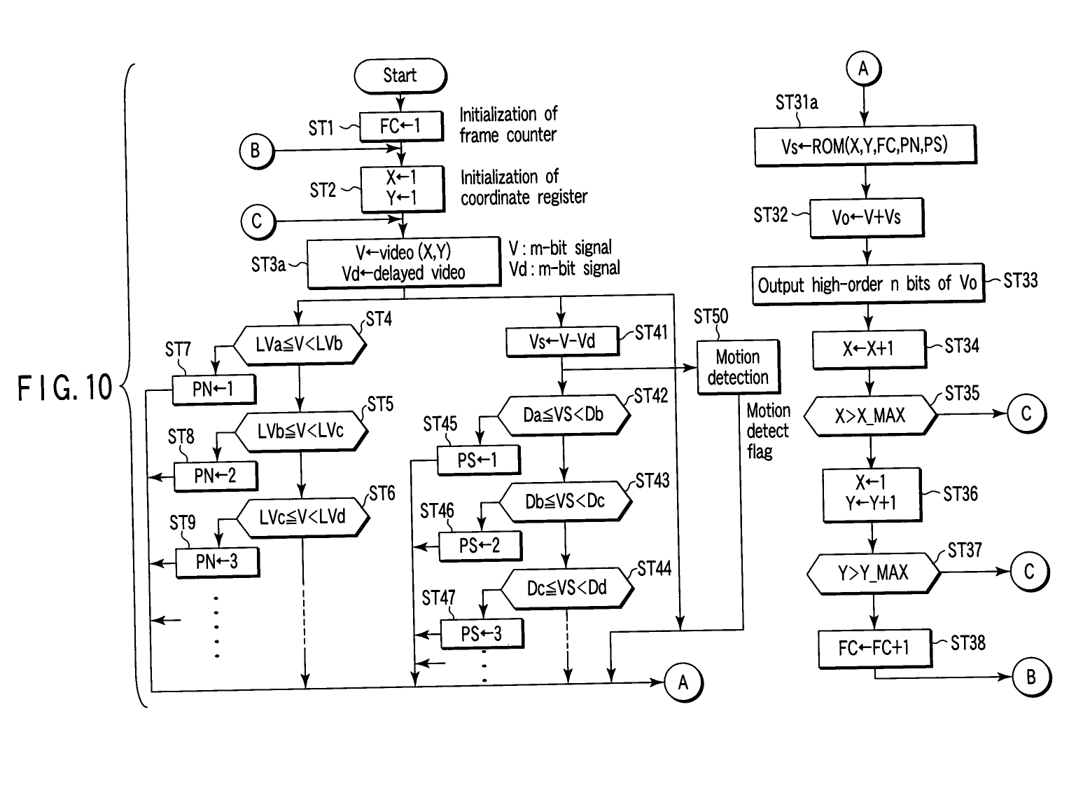

FIG. 10 shows a flowchart corresponding to the functional blocks shown in FIG. 5. In this diagram, corresponding parts to those in FIG. 9 are denoted by like reference numerals and descriptions thereof are omitted. FIG. 10 is different from FIG. 9 in that step ST41 is followed by a motion detecting step ST 50. When image motion exceeds a set value and consequently a motion detect flag is output, switching is forcibly made to a frame rate lower than the current frame rate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video signal processing device comprising:
a gradation representation pattern information storage circuit storing a plurality of pieces of gradation representation pattern information which are different in the number of repetition unit frames for gradation representation according to a plurality of degradation regions;
a gradation region detection circuit detecting a gradation region in an input video signal;
a pattern information selection circuit selecting one piece of gradation representation pattern information stored in the gradation representation pattern information storage circuit according to the gradation region detected by the gradation region detection circuit; and
an output circuit outputting gradation representation data of the frame rate corresponding to the gradation representation pattern information selected by the pattern information selection circuit.

2. The video signal processing device according to claim 1, wherein the number of repetition unit frames of the gradation representation pattern information stored in the gradation representation pattern information storage circuit is such that the number of frames for intermediate gradation regions is large and the number of frames for high and low gradation regions is small.

3. The video signal processing device according to claim 1, further comprising a one-frame delay memory and wherein the gradation region detection circuit uses video signals in the current and preceding frames to selectively switch from a frame rate to another according to a change in gradation level.

4. The video signal processing device according to claim 1, further comprising a motion detection circuit, and wherein the gradation region detection circuit responds to a motion detect signal from the motion detection circuit and, when image motion is large, forces the pattern information selection circuit to select gradation representation pattern information for a low frame rate even if a frame rate for intermediate gradation has been set.

5. A display device comprising:
a gradation representation pattern information storage circuit storing a plurality of pieces of gradation representation pattern information which are different in the number of repetition unit frames for gradation representation according to a plurality of degradation regions;
a gradation region detection circuit detecting a gradation region in an input video signal;
a pattern information selection circuit selecting one piece of gradation representation pattern information stored in the gradation representation pattern information storage circuit according to the gradation region detected by the gradation region detection circuit;
an output circuit outputting gradation representation data of the frame rate corresponding to the gradation representation pattern information selected by the pattern information selection circuit; and
a display panel being supplied with the gradation representation data.

6. The display device according to claim 5, wherein the number of repetition unit frames of the gradation representation pattern information stored in the gradation representation pattern information storage circuit is such that the number of frames for intermediate gradation regions is large and the number of frames for high and low gradation regions is small.

7. The display device according to claim 5, further comprising a one-frame delay memory and wherein the gradation region detection circuit uses video signals in the current and preceding frames to selectively switch from a frame rate to another according to a change in gradation level.

8. The display device according to claim 5, further comprising a motion detection circuit, and wherein the gradation region detection circuit responds to a motion detect signal from the motion detection circuit and, when image motion is large, forces the pattern information selection circuit to select gradation representation pattern information for a low frame rate even if a frame rate for intermediate gradation has been set.

9. The display device according to claim 5, wherein the input video signal is a signal from a receiver or set-top box.

10. A television signal receiver comprising:
a tuner receiving broadcast signals;
a video signal processing unit being supplied with a signal selected by the tuner and includes a gradation representation pattern information storage circuit which stores a plurality of pieces of gradation representation pattern information which are different in the number of repetition unit frames for gradation representation according to a plurality of degradation regions, a gradation region detection circuit which detects a gradation region in an input video signal, a pattern information selection circuit which selects one piece of gradation representation pattern information stored in the gradation representation pattern information storage circuit according to the gradation region detected by the gradation region detection circuit, and an output circuit which outputs gradation representation data of the frame rate corresponding to the gradation representation pattern information selected by the pattern information selection circuit; and
a display panel being supplied with the gradation representation data.

11. A video signal processing method comprising the steps of:
preparing a plurality of pieces of gradation representation pattern information which are different in the number of repetition unit frames for gradation representation according to a plurality of degradation regions;
detecting a gradation region in an input video signal;
selecting one piece of gradation representation pattern information prepared, according to the gradation region detected by the detecting step; and
outputting gradation representation data of the frame rate corresponding to the selected gradation representation pattern information to a display unit.

12. The video signal processing method according to claim 11,
said detecting step including a step obtaining an interframe difference value of the video signal and detecting a gradation region according to the interframe difference value.

13. The video signal processing method according to claim 12,
further comprising a step detecting an image motion value, and said selecting step being controlled according to the image motion value.

14. The video signal processing method according to claim 13,
wherein the selecting step forcibly switches the piece of gradation representation pattern information to a frame rate indication lower than a current frame rate indication, when the image motion value is exceeds a set value.
